(19) United States
(12) Patent Application Publication
(10) Pub. No.: US 2007/0248861 A1
(43) Pub. Date: Oct. 25, 2007

(54) COOLING DEVICE FOR FUEL CELLS AND MOTOR VEHICLE EQUIPPED WITH SUCH COOLING DEVICE

(75) Inventor: Jun Hoshi, Aichi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, TOYOTA-SHI (JP)

(21) Appl. No.: 11/628,360

(22) PCT Filed: Jun. 10, 2005
(86) PCT No.: PCT/JP05/11083

§ 371 Date: Dec. 4, 2006

(30) Foreign Application Priority Data
Jun. 10, 2004 (JP) 2004-172697

(51) Int. Cl. H01M 8/12

(52) U.S. Cl. 429/26

(57) ABSTRACT

A cooling water flow path 41 connected with a radiator 40 includes a fuel cell flow path 41a that makes circulation of cooling water from the radiator 40 via a fuel cell stack 20 to the radiator 40, and an exothermic equipment flow path 41b that is placed in parallel to the fuel cell flow path 41a and makes circulation of cooling water from the radiator 40 via exothermic equipment 13 (including an inverter 32 of a power control unit (PCU) 30, an air supplier 26, a heat exchanger 27, and a driving motor 35) to the radiator 40. The multiple pieces of exothermic equipment 13 are arranged in series along the exothermic equipment flow path 41b in the flow direction of cooling water in an ascending order of heat discharge quantity. The inverter 32, the heat exchanger 27, and the driving motor 35 are respectively equipped with a dual cooling mechanism, an air cooling mechanism, and an oil cooling mechanism. The arrangement of the invention ensures stable operations of the respective pieces of exothermic equipment 13 even when the cooling water used for cooling down the exothermic equipment 13 has a higher temperature.

### BACKGROUND ART

A proposed cooling device for fuel cells has a first cooling medium flow path that makes the flow of a first cooling medium for cooling down fuel cells, a second cooling medium flow path that makes the flow of a second cooling medium for cooling down exothermic equipment (for example, a driving motor), a radiator that is placed in the second cooling medium flow path and cools down the second cooling medium, and a heat exchanger that attains heat exchange between the first cooling medium and the second cooling medium (see, for example, Japanese Patent Laid-Open Gazette No. 2000-323146). In this proposed cooling device, the second cooling medium cools down the exothermic equipment and is subjected to heat exchange with the first cooling medium. The first cooling medium after the heat exchange cools down the fuel cells. The radiator removes heat from the second cooling medium that is heated up in the process of cooling down the exothermic equipment. This prior art cooling device uses only one radiator to cool down both the fuel cells and the exothermic equipment.

### DISCLOSURE OF THE INVENTION

The prior art cooling device disclosed in the cited reference requires the heat exchanger to attain heat exchange between the first cooling medium and the second cooling medium, the two independent flow paths, that is, the first cooling medium flow path and the second cooling medium flow path, and a circulation pump for circulating the cooling medium in the respective flow paths. This undesirably increases the total number of required parts constituting a fuel cell system.

The object of the invention is thus to eliminate the drawback of the prior art and to provide a cooling device for fuel cells that has a simplified structure to effectively cool down a fuel cell system. The object of the invention is also to provide a vehicle equipped with such a cooling device for fuel cells.

In order to attain at least part of the above and the other related objects, the present invention is directed to a cooling device for fuel cells, which includes: fuel cells that generate electric power through an electrochemical reaction of a fuel gas with an oxidizing gas; exothermic equipment that is different from the fuel cells and produces heat during operation thereof; a cooling medium flow path that is arranged to make circulation of a cooling medium and cool down the fuel cells and the exothermic equipment; and a radiator that is connected with the cooling medium flow path to remove heat from the cooling medium.

The cooling device of the invention uses only one radiator to remove heat from the common cooling medium, which is flowed through the fuel cells and the exothermic equipment to cool down both the fuel cells and the exothermic equipment. This arrangement desirably simplifies the structure of effectively cooling down the fuel cell system, compared with the conventional structure using different cooling media and separate radiators for the fuel cells and for the exothermic equipment. Here the ‘exothermic equipment’ may be any of auxiliary machinery used for power generation of the fuel cells (for example, auxiliary machinery for supplying the fuel gas and the oxidizing gas) or auxiliary machinery used for conversion of the electric power generated by the fuel cells (for example, auxiliary machinery for voltage conversion, direct current-alternating current conversion, or frequency conversion, or auxiliary machinery for converting the electric power to heat or converting the electric power to driving force). The terminology ‘to cool down the exothermic equipment’ means not only to directly cool down the exothermic equipment but to cool down a preset object used by the exothermic equipment (for example, the oxidizing gas supplied by an oxidizing gas supplier).

In one preferable embodiment of the cooling device of the invention, the exothermic equipment includes multiple pieces of exothermic equipment, and the fuel cells and the multiple pieces of exothermic equipment are arranged along the cooling medium flow path, based on allowable operating temperatures. This structure disposes the fuel cells and the exothermic equipment based on their allowable operating temperatures and accordingly keeps the temperatures of the fuel cells and the exothermic equipment within the respective allowable operating temperatures. In the cooling device of this embodiment, at least the multiple pieces of exothermic equipment may be arranged in series along the cooling medium flow path in a flow direction of the cooling medium in an ascending order of allowable operating temperature. The ‘allowable operating temperature’ may be temperatures that allow stable operations of the fuel cells and the exothermic equipment.

In another preferable embodiment of the cooling device of the invention, the exothermic equipment includes multiple pieces of exothermic equipment, and the fuel cells and the multiple pieces of exothermic equipment are arranged along the cooling medium flow path, based on heat discharge quantities. This structure disposes the fuel cells and the exothermic equipment based on their heat discharge quantities to effectively cool down the fuel cells and the exothermic equipment. In the cooling device of this embodiment, at least the multiple pieces of exothermic equipment may be arranged in series along the cooling medium flow path in a flow direction of the cooling medium in an ascending order of heat discharge quantity.

In one preferable application of the cooling device of the invention, the cooling medium flow path includes a fuel cell flow path that makes circulation of the cooling medium from the radiator via the fuel cells to the radiator, and at least one exothermic equipment flow path that is placed in parallel to the fuel cell flow path and makes circulation of the cooling medium from the radiator via the exothermic equipment to the radiator. Unlike the structure of arranging the fuel cells and the exothermic equipment in series along the flow direction of the cooling medium, this arrangement effectively prevents the exothermic equipment from heating up the flow of the cooling medium running through the fuel cells and similarly prevents the fuel cells from heating up the flow of the cooling medium running through the exothermic equipment, thus attaining the effective and efficient cooling of both the fuel cells and the exothermic equipment.

In the cooling device of this application, the exothermic equipment includes multiple pieces of exothermic equipment, and the multiple pieces of exothermic equipment are arranged in series along the exothermic equipment flow path in a flow direction of the cooling medium in an ascending order of allowable operating temperature. This arrangement cools down the exothermic equipment having a lower allowable operating temperature at an earlier timing, thus effectively keeping the temperature of the exothermic equipment within the allowable operating temperature.

In the cooling device of the above application, the exothermic equipment includes multiple pieces of exothermic equipment, and the multiple pieces of exothermic equipment are arranged in series along the exothermic equipment flow path in a flow direction of the cooling medium in an ascending order of heat discharge quantity. Namely the exothermic equipment having the smaller heat discharge quantity is disposed in the upper stream of the flow of the cooling medium. This arrangement desirably minimizes the temperature rise of the cooling medium in the process of cooling down each piece of exothermic equipment and thus attains the effective and efficient cooling of the respective pieces of exothermic equipment arranged in the flow direction of the cooling medium.

In one preferable embodiment of the cooling device of the invention, the exothermic equipment includes a power converter that uses a semiconductor chip to convert the electric power generated by the fuel cells. The semiconductor chip of the power converter (for example, an inverter, a DC-DC converter, or a booster converter) is not normally operable at temperatures exceeding the allowable operating temperature. It is accordingly required to regulate the temperature of the power converter by means of the cooling medium and the radiator. The technique of the present invention is thus preferably applied to the power converter.

In the cooling device of this embodiment, the power converter preferably has a dual cooling mechanism that makes the cooling medium remove heat directly or indirectly from both faces of the semiconductor chip to cool down the semiconductor chip. The dual cooling mechanism cools down both the faces of the semiconductor chip and attains the more sufficient cooling of the semiconductor chip, compared with the structure of cooling down only a single face of the semiconductor chip. Even the flow of the cooling medium at a relatively high temperature thus ensures the stable operations of the power converter. In the cooling device of the above embodiment, the power converter alternatively has an ebullient cooling mechanism that utilizes a phase change medium vaporized to remove heat from the semiconductor chip, and makes the cooling medium remove heat from the vaporized phase change medium to cool down the semiconductor chip. The ebullient cooling mechanism utilizes the evaporative latent heat produced in the course of ebullience of the phase change medium to sufficiently cool down the semiconductor chip. Even the flow of the cooling medium at a relatively high temperature thus ensures the stable operations of the power converter.

In another preferable embodiment of the cooling device of the invention, the exothermic equipment includes an oxidizing gas supplier that supplies the oxidizing gas to the fuel cells. The oxidizing gas supplier typically has a motor. The motor has a relatively high heat release value during operation. It is accordingly required to regulate the temperature of the motor by means of the cooling medium and the radiator. The technique of the present invention is thus preferably applied to the oxidizing gas supplier.

In the cooling device of this embodiment, the oxidizing gas supplier preferably has a heat exchanger that makes the cooling medium remove heat from the oxidizing gas to cool down the oxidizing gas. The oxidizing gas supplied from the oxidizing gas supplier may be compressed to have a high temperature. The supply of the hot oxidizing gas to the fuel cells may cause a thermal damage of the internal elements of the fuel cells. It is accordingly required to regulate the temperature of the oxidizing gas supplied from the oxidizing gas supplier by means of the cooling medium and the radiator. The technique of the present invention is thus preferably applied to the heat exchanger for cooling down the oxidizing gas. The heat exchanger may cool down the oxidizing gas through multiple cycles of heat exchange between the cooling medium and the oxidizing gas. The multiple cycles of heat exchange between the oxidizing gas and the cooling medium attain the sufficient cooling of the oxidizing gas. Even the flow of the cooling medium at a relatively high temperature for cooling down the oxidizing gas thus ensures the stable power generation of the fuel cells.

In still another preferable embodiment of the cooling device of the invention, the exothermic equipment includes a driving motor that produces a driving force. The driving motor (that may be mounted on a vehicle) has a relatively high heat release value during operation. It is accordingly required to regulate the temperature of the driving motor by means of the cooling medium and the radiator. The technique of the present invention is thus preferably applied to the driving motor.

In the cooling device of this embodiment, the driving motor preferably has an oil cooling mechanism that oil-cools inside of the driving motor. The oil cooling mechanism oil-cools the inside of the driving motor and attains the sufficient cooling of the driving motor. Even the flow of the cooling medium at a relatively high temperature thus ensures the stable operations of the driving motor.

The present invention is also directed to another cooling device for fuel cells, which includes: fuel cells that generate electric power through an electrochemical reaction of a fuel gas with an oxidizing gas; a power converter that uses a semiconductor chip to convert the electric power generated by the fuel cells; an oxidizing gas supplier that supplies the oxidizing gas to the fuel cells; a driving motor that produces a driving force; a cooling medium flow path that is formed to make circulation of a cooling medium through the fuel cells, the power converter, the oxidizing gas supplier, and the driving motor and cool down the fuel cells, the power converter, the oxidizing gas supplier, and the driving motor; and a radiator that is connected with the cooling medium flow path to remove heat from the cooling medium.

The cooling device of the invention uses only one radiator to remove heat from the common cooling medium, which is flowed through the fuel cells, the power converter, the oxidizing gas supplier, and the driving motor to cool down the fuel cells, the power converter, the oxidizing gas supplier, and the driving motor. This arrangement desirably simplifies the structure of effectively cooling down the fuel cell system, compared with the conventional structure using different cooling media and separate radiators for the fuel cells and for such exothermic equipment. The power converter, the oxidizing gas supplier, the driving motor, and the cooling medium flow path may be those described above.

The present invention is directed to a vehicle equipped with any one of modifications, changes, and alteration of the invention described above. The invention provides a cooling device for fuel cells that has a simplified structure to effectively cool down a fuel cell system. A vehicle equipped with such a cooling device thus exerts the similar effects to those of the cooling device for fuel cells.

### BRIEF DESCRIPTION OF THE DRAWINGS

FIG. 1 is a block diagram schematically illustrating the configuration of a fuel-cell vehicle 10 equipped with a fuel cell system in one embodiment of the invention;

FIG. 2 is a plan view showing a dual cooling mechanism 50 in the embodiment;

FIG. 3 is a sectional view taken on the line A-A in FIG. 2;

FIG. 4 illustrates an air cooling mechanism 27a in the embodiment;

FIG. 5 illustrates an oil cooling mechanism 60 in the embodiment;

FIG. 6 is a sectional view taken on the line B-B in FIG. 5;

FIG. 7 illustrates an ebullient cooling mechanism in the embodiment.

### BEST MODE OF CARRYING OUT THE INVENTION

One mode of carrying out the invention is described below as a preferred embodiment with reference to the accompanied drawings.

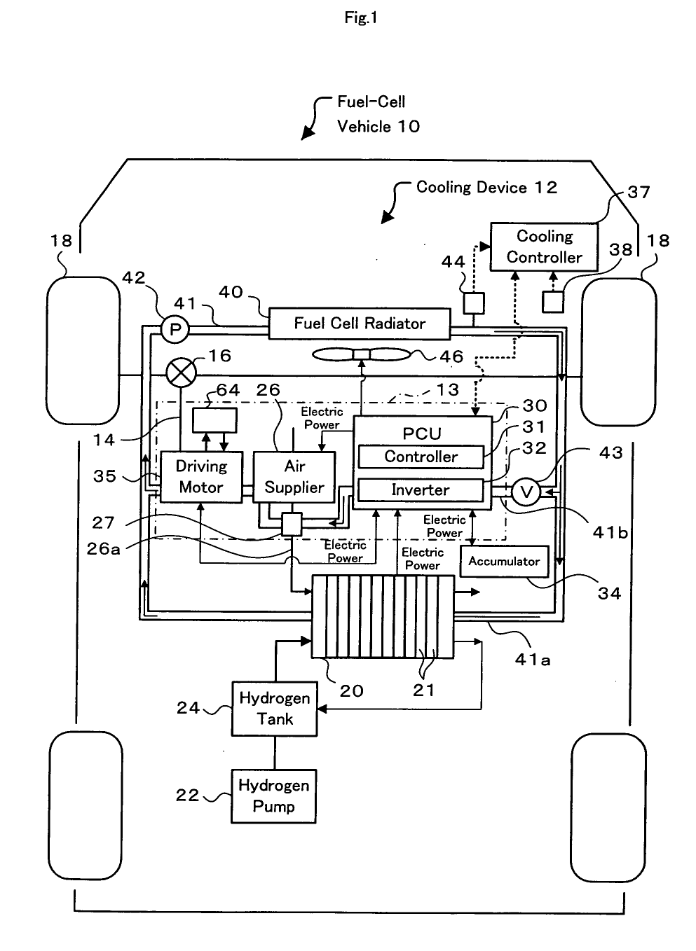

FIG. 1 is a block diagram schematically illustrating the configuration of a fuel-cell vehicle 10 equipped with a fuel cell system. The fuel cell system mounted on the fuel-cell vehicle 10 includes a stack of fuel cells (hereafter referred to as fuel cell stack) 20 that generates electric power through electrochemical reactions of hydrogen (fuel gas) supplied from a hydrogen tank 22 by means of a hydrogen pump 24 with oxygen included in the air (oxidizing gas) supplied by an air supplier 26, an accumulator 34 that is chargeable with electric power and is dischargeable to supply the accumulated electric power, a driving motor 35 that is activated with electric power to drive and rotate drive wheels 18,18, a power control unit (PCU) 30 that controls the whole fuel cell system, and a cooling device 12 that cools down the fuel cell stack 20 and exothermic equipment 13 producing heat during their operations. The cooling device 12 includes a radiator 40 that removes heat from the flow of cooling water circulated through the exothermic equipment 13 and the fuel cell stack 20, and a cooling controller 37 that controls the cooling operations in the fuel cell system. The constituents of the cooling device 12 are described below in detail.

The radiator 40 is located in a front portion of the fuel-cell vehicle 10 to vent the air and accordingly remove heat from the flow of cooling water circulated through the fuel cell stack 20 and through the exothermic equipment 13 (including an inverter 32 of the PCU 30, the air supplier 26, a heat exchanger 27, and the driving motor 35) of the fuel cell system producing heat during their operations. The radiator 40 is connected with a cooling water flow path 41, through which the flow of cooling water is circulated. The cooling water flow path 41 includes a fuel cell flow path 41a that makes circulation of cooling water from the radiator 40 via the fuel cell stack 20 to the radiator 40, and an exothermic equipment flow path 41b that makes circulation of cooling water from the radiator 40 via the exothermic equipment 13 to the radiator 40. The exothermic equipment flow path 41b is located parallel to the fuel cell flow path 41a. The inverter 32 of the PCU 30, the heat exchanger 27, the air supplier 26, and the driving motor 35 are arranged in series along the exothermic equipment flow path 41b in the flow direction of cooling water in this ascending order of heat discharge quantity. A throttle valve 43 is located close to an inlet of the exothermic equipment flow path 41b to make a fixed flow rate of cooling water (for example, 10 liters/minute) run through the exothermic equipment flow path 41b, while the circulating flow of cooling water runs at a preset flow rate (for example, 100 liters/minute) through the fuel cell flow path 41a. A circulation pump 42 is provided in the cooling water flow path 41 to make the circulating flow of cooling water. A cooling water temperature sensor 44 is placed downstream the radiator 40 in the cooling water flow path 41 to measure a cooling water temperature Tf. The cooling water temperature sensor 44 is electrically connected with the cooling controller 37.

A resin-made cooling fan 46 is located downstream the radiator 40 to forcibly blow the outside air into the radiator 40 and is driven and rotated by a motor (not shown). The cooling fan 46 is under control of the cooling controller 37 via the PCU 30.

The cooling controller 37 includes a CPU, a ROM, and a RAM to control the cooling operations of the fuel cell stack 20. A vehicle speed sensor 38 is electrically connected with the cooling controller 37. The cooling controller 37 has input and output ports (not shown) and receives signals from the cooling water temperature sensor 44 and from the vehicle speed sensor 38 via the input port. The cooling controller 37 is electrically connected with the PCU 30 via the input port and the output port to transmit diversity of control signals and data to and from the PCU 30. The cooling controller 37 outputs diversity of driving signals, for example, driving signals for driving the cooling fan 46, via the output port to the PCU 30. The cooling controller 37 receives the supply of electric power under control of the PCU 30 to drive and control the relevant units and elements involved in the cooling operations.

The PCU 30 includes a controller 31 constructed as a microcomputer-based logic circuit and the inverter 32 that exchanges the high-voltage direct current of the fuel cell stack 20 and the accumulator 34 with the alternating current of the driving motor 35. The controller 31 of the PCU 30 controls the supply of the electric power generated by the fuel cell stack 20 to the driving motor 35 and to the accumulator 34, as well as the supply of the electric power accumulated in the accumulator 34 to the driving motor 35, based on the loading of the driving motor 35 and the state of charge of the accumulator 34. The controller 31 of the PCU 30 also controls the supply of regenerative electric power, which is generated by the driving motor 35 during deceleration or braking, to the accumulator 34. The PCU 30 has an input port and an output port (not shown). Diversity of control signals, for example, those from the cooling controller 37 are input into the controller 31 of the PCU 30 via the input port.

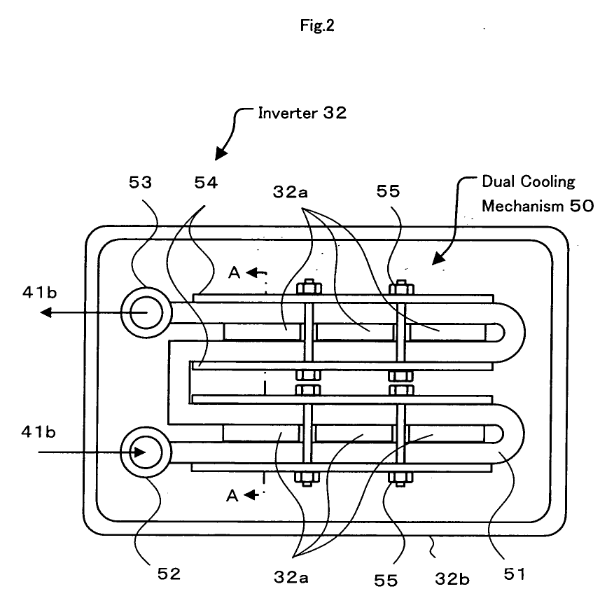

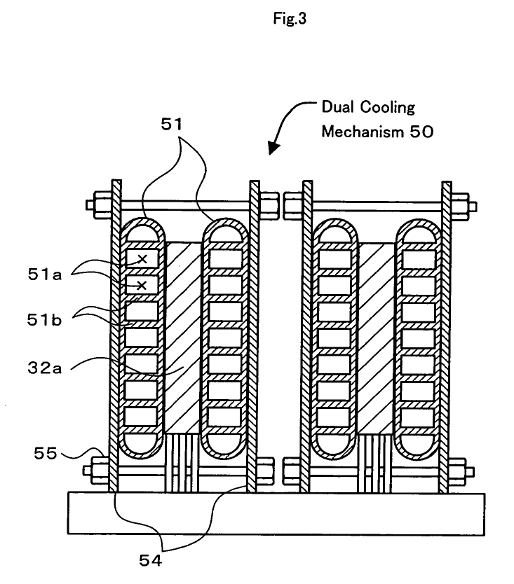

The inverter 32 is a power converter that uses a three-phase bridge circuit including semiconductor chips 32a (for example, IGBT elements) as power transistors to exchange the direct current with the three-phase alternating current and to convert the voltage level of electric power to be supplied. The inverter 32 is electrically connected with the controller 31 of the PCU 30 and is under control of the controller 31. FIG. 2 is a plan view showing an inverter casing 32b that keeps therein the semiconductor chips 32a of the inverter 32. FIG. 3 is a sectional view taken on the line A-A in FIG. 2. As shown in FIGS. 2 and 3, the inverter 32 has a dual cooling mechanism 50 that causes the flow of cooling water to remove the heat from both faces of the individual semiconductor chips 32a and accordingly cool down the semiconductor chips 32a. The dual cooling mechanism 50 includes a cooling water tube 51 that is connected with the exothermic equipment flow path 41b to make the circulating flow of cooling water, pairs of clamping plates 54 that clamp therebetween the cooling water tube 51 arranged to run through both the faces of the individual semiconductor chips 32a, fixtures 55 that fix the pairs of clamping plates 54, and connectors 52, 53 that connect the cooling water tube 51 with the exothermic equipment flow path 41b. Silicone grease for enhancing the thermal conductivity is applied on the contact faces between the semiconductor chips 32a and the cooling water tube 51. The cooling water tube 51 has inner support wall elements 51b to allow the smooth circulation of cooling water through circulation holes 51a under clamping pressure of the clamping plates 54. The inverter 32 has a low heat release value and has a relatively low allowable operating temperature. The allowable operating temperature is specified as a temperature level that ensures stable operations of the exothermic equipment 13 and the fuel cell stack 20.

The accumulator 34 includes multiple nickel hydrogen batteries connected in series and functions as a high-voltage power source (several hundred V). The accumulator 34 is under control of the PCU 30 to activate the driving motor 35 on a start of the fuel-cell vehicle 10, to assist the driving motor 35 during acceleration, and to supply the electric power to the exothermic equipment 13. The accumulator 34 recovers the regenerative electric power from the driving motor 35 during regenerative deceleration and is charged by the fuel cell stack 20 according to the state of charge. The accumulator 34 may be replaced by an electric double layer capacitor.

The fuel cell stack 20 has a stack structure of multiple unit cells 21 and works as a high-voltage power source (several hundred V). The unit cells 21 are known polymer electrolyte fuel cells. Each unit cell 21 of the fuel cell stack 20 produces an electromotive force through predetermined electrochemical reactions of hydrogen (the fuel gas) with oxygen (the air) proceeding at an anode and a cathode. The hydrogen gas from the hydrogen tank 22 is regulated to appropriate pressure and flow rate by the hydrogen pump 24 and is supplied as the fuel gas to the anodes of the unit cells 21, while the air is compressed to have a regulated pressure by the air supplier 26 and is supplied to the cathodes of the unit cells 21. The unreacted excess hydrogen gas is flowed back to the hydrogen pump 24 to be recycled as part of the fuel gas. In order to keep the high power generation efficiency of the fuel cell stack 20, the flow of cooling water circulated through the fuel cell stack 20 should be regulated to or below a preset temperature, for example, 80° C., to sufficiently cool down the fuel cell stack 20. The preset temperature is higher than the temperature of the cooling water flowing through the exothermic equipment 13 without an exothermic equipment cooling mechanism including the dual cooling mechanism 50, an air cooling mechanism 27a, and an oil cooling mechanism 60 (described later).

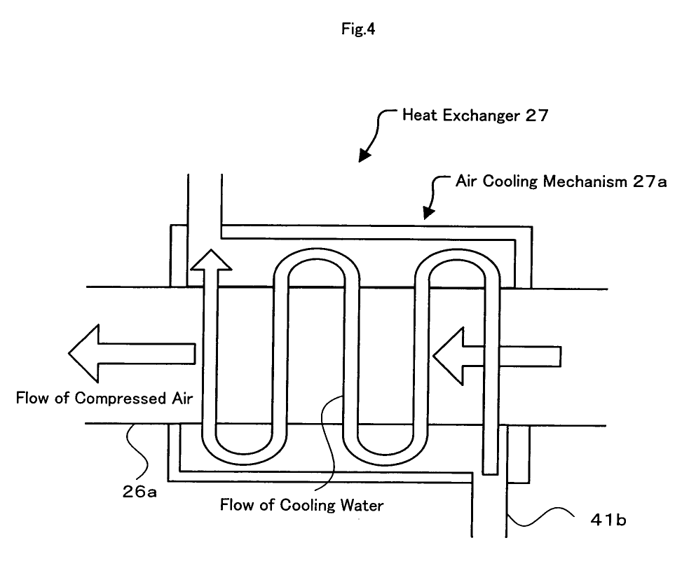

The air supplier 26 is a compressor that compresses the air by means of a motor (not shown) and supplies the compressed air to an air supply conduit 26a. As shown in FIG. 4, the heat exchanger 27 is provided in the air supply conduit 26a as a passage of the compressed air supplied from the air supplier 26. The heat exchanger 27 cools down the hot compressed air, prior to supply to the fuel cell stack 20. The heat exchanger 27 has the air cooling mechanism 27a that is arranged in the flow direction of the compressed air and makes the flow of cooling water with multiple cycles of heat exchange. The supply of the hot compressed air to the fuel cell stack 20 may undesirably cause a thermal damage of the internal elements of the unit cells 21. The compressed air accordingly has a low allowable operating temperature. While the compressed air has a relatively low heat discharge quantity, the motor of the air supplier 26 has a relatively high heat release value. The exothermic equipment flow path 41b is formed outside the motor to make the circulating flow of cooling water and cool down the exothermic equipment 13. The motor has a relatively high level of allowable operating temperature.

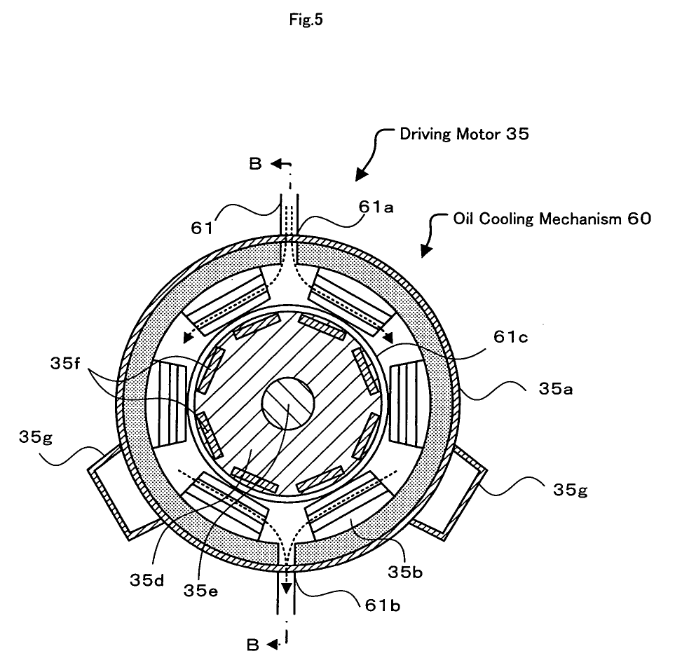

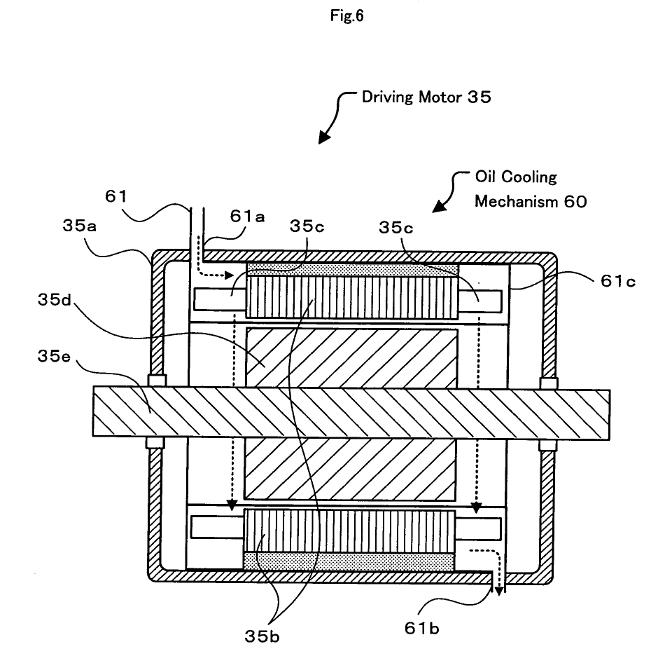

The driving motor 35 is a three-phase synchronous motor and receives a supply of electric power, which is obtained by conversion of the direct current output from the fuel cell stack 20 into three-phase alternating current by the PCU 30, to produce a driving force. The driving force produced by the driving motor 35 is transmitted through a driveshaft 14 and a differential gear 16 and is eventually output to the drive wheels 18,18 to run the fuel-cell vehicle 10. FIG. 5 is a vertical sectional view along the longitudinal direction of the driving motor 35. FIG. 6 is a sectional view taken on the line B-B in FIG. 5. As shown in FIGS. 5 and 6, the driving motor 35 includes a stator 35b that is fastened to a motor casing 35a and has a winding of coil thereon, coil ends 35c as two ends of the coil wound on the stator 35b, a motor shaft 35e that is arranged inside the stator 35b in the radial direction and is supported on the motor casing 35a in a rotatable manner, a rotor 35d that is formed integrally with the outer circumference of the motor shaft 35e, and the oil cooling mechanism 60 that uses an insulating oil to oil-cool the inside of the driving motor 35. Permanent magnets 35f are set on the outer circumference of the rotor 35d to have alternate N and S poles (see FIG. 5). The oil cooling mechanism 60 of the driving motor 35 has an oil flow path 61 and brings the oil flow in contact with the stator 35b to cool down the stator 35b. The oil flow path 61 has an oil supply inlet 61a formed on the top of the motor casing 35a to receive a supply of oil fed by an oil pump 64 (see FIG. 1). The oil flow path 61 has an oil jacket 61c formed inside the driving motor 35 to prevent the oil flow introduced through the oil supply inlet 61a from coming in contact with the rotor 35d. The flow of oil runs along the oil jacket 61c with free of contact with the rotor 35d and comes into contact with the coil ends 35c and the stator 35b. An oil discharge outlet 61b is formed on the bottom of the motor casing 35a to discharge the oil flowed along the oil jacket 61c. The oil flow is introduced through the oil supply inlet 61a to cool down the stator 35b and is discharged from the oil discharge outlet 61b to be recirculated. The motor casing 35a also has a water jacket 35g that is formed on a lower outer wall of the motor casing 35a and is connected with the endothermic equipment flow path 41b to make the flow of cooling water along the longitudinal direction of the driving motor 35. The heat produced in the stator 35b is transmitted via the oil flow to the motor casing 35a, and the heat of the motor casing 35a is removed by the flow of cooling water through the water jacket 35g. The driving motor 35 used for driving the fuel-cell vehicle 10 has a high heat release value and a relatively high level of allowable working temperature. In the structure of this embodiment, the oil flow comes into contact with the whole stator 35b. The oil flow may alternatively come into contact with only a predetermined part of the stator 35b (for example, the coil ends 35c).

The cooling device 12 of this structure mounted on the fuel-cell vehicle 10 has the operations as described below. On a start of the fuel-cell vehicle 10, the cooling controller 37 activates the circulation pump 42 to make the circulating flow of cooling water run at a preset flow rate (for example, 100 liters/minute) through the fuel cell flow path 41a, and actuates the oil pump 64 to make the circulating flow of oil inside the driving motor 35. The cooling controller 37 subsequently inputs the current measurement values of cooling water temperature Tf and vehicle speed v. When the input cooling water temperature Tf exceeds a preset level (for example, 80° C.), the cooling controller 37 sets a voltage V for rotating the cooling fan 46 based on the cooling water temperature Tf and the vehicle speed v and drives and rotates the cooling fan 46 at the set voltage V. The higher voltage V is set according to the higher cooling water temperature Tf and the higher vehicle speed v. This increases the air flow passing through the radiator 40 with an increase in heat release value of the fuel cell stack 20. When the input cooling water temperature Tf is not higher than the preset level, on the other hand, there is no need of cooling down the flow of cooling water. The cooling controller 37 accordingly changes over the setting of a valve (not shown) not to make the flow of cooling water run through the radiator 40 but to introduce the flow of cooling water into a bypass flow path (not shown).

While the circulation pump 42 is activated to make the circulating flow of cooling water through the fuel cell flow path 41a at the preset flow rate (for example, 100 liters/minute), a fixed flow rate of cooling water (for example, 10 liters/minute) regulated by the throttle valve 43 runs through the exothermic equipment flow path 41b. The flow of cooling water runs through the cooling water tube 51 of the dual cooling mechanism 50 to cool down both the faces of the individual semiconductor chips 32a included in the inverter 32. The semiconductor chips 32a have a relatively low heat release value, so that there is a relatively small temperature rise of cooling water downstream the semiconductor chips 32a. The flow of cooling water then runs through the air cooling mechanism 27a of the heat exchanger 27 and cools down the flow of compressed air supplied to the fuel cell stack 20 through multiple cycles of heat exchange between the compressed air and the cooling water. The flow of cooling water subsequently cools down the motor of the air supplier 26 that supplies the compressed air. The air supplier 26 has a relatively high heat release value. The flow of cooling water runs through the water jacket 35g of the driving motor 35 to cool down the driving motor 35. The oil flow is circulated inside the driving motor 35 by means of the oil pump 64, and the heat produced in the stator 35b is transmitted via the oil flow to the motor casing 35a. The heat of the motor casing 35a is removed by the flow of cooling water. The driving motor 35 for driving the fuel-cell vehicle 10 has a high heat release value. The flow of cooling water that is heated up in the process of cooling down the exothermic equipment 13 joins with the flow of cooling water that is heated up in the process of cooling down the fuel cell stack 20. The air flow vented by the radiator 40 removes heat from the flow of cooling water and accordingly cools down the cooling water.

As described above, the cooling device 12 of the embodiment mounted on the fuel-cell vehicle 10 makes the common circulating flow of cooling water run through the fuel cell stack 20 and the exothermic equipment 13 to cool down both the fuel cell stack 20 and the exothermic equipment 13 and uses one radiator 40 to remove the heat from the flow of cooling water. This arrangement desirably simplifies the structure of cooling down the fuel cell system, compared with the conventional cooling structure using different flows of cooling media and separate radiators for the fuel cell stack 20 and the exothermic equipment 13. The cooling water flow path 41 includes the fuel cell flow path 41a that makes circulation of cooling water from the radiator 40 via the fuel cell stack 20 to the radiator 40, and the exothermic equipment flow path 41b that makes circulation of cooling water from the radiator 40 via the exothermic equipment 13 to the radiator 40. Unlike the structure of arranging the fuel cell stack 20 and the exothermic equipment 13 in series along the flow direction of cooling water, the arrangement of this embodiment effectively prevents the exothermic equipment 13 from heating up the flow of cooling water running through the fuel cell stack 20 and similarly prevents the fuel cell stack 20 from heating up the flow of cooling water running through the exothermic equipment 13, thus attaining the effective and efficient cooling of the fuel cell stack 20 and the exothermic equipment 13.

Among the exothermic equipment 13, the heat discharge quantity increases in the order of the inverter 32 of the PCU 30, the heat exchanger 27, the air supplier 26, the driving motor 35. The inverter 32 of the PCU 30, the heat exchanger 27, the air supplier 26, and the driving motor 35 among the exothermic equipment 13 are arranged in series along the exothermic equipment flow path 41b in the flow direction of cooling water in this ascending order of heat discharge quantity. Namely the exothermic equipment 13 having the smaller heat discharge quantity is disposed in the upper stream of the flow of cooling water. This arrangement desirably minimizes the temperature rise of cooling water in the process of cooling down each piece of exothermic equipment 13 and thus attains the effective and efficient cooling of the respective pieces of exothermic equipment 13 arranged in the flow direction of cooling water.

The exothermic equipment 13 include the inverter 32 that uses the semiconductor chips 32a to convert the electric power generated by the fuel cell stack 20. The semiconductor chips 32a of the inverter 32 are not operable at higher temperatures exceeding the allowable operating temperature. It is accordingly important to regulate the temperature of the inverter 32 and cool down the inverter 32 by means of the flow of the cooling medium and the radiator 40. The technique of the invention is thus preferably applied to the inverter 32. The inverter 32 has the dual cooling mechanism 50 that makes the circulating flow of cooling water to remove the heat from both the faces of the individual semiconductor chips 32a and thereby cool down the semiconductor chips 32a. This arrangement attains the sufficient cooling of the semiconductor chips 32a, compared with the structure of cooling only the single faces of the individual semiconductor chips 32a. Even the flow of cooling water at a relatively higher temperature for cooling down the semiconductor chips 32a thus ensures the stable operations of the inverter 32.

The exothermic equipment 13 also include the air supplier 26 that supplies the compressed air to the fuel cell stack 20. The motor of the air supplier 26 has a relatively high heat release value during its operations. It is accordingly important to regulate the temperature of the motor of the air supplier 26 and cool down the motor by means of the flow of the cooling medium and the radiator 40. The technique of the invention is thus preferably applied to the motor of the air supplier 26. The air supplier 26 is equipped with the heat exchanger 27 that makes the circulating flow of cooling water to remove the heat from the compressed air and thereby cool down the compressed air. The compressed air may be heated to have a high temperature. The supply of the hot compressed air to the fuel cell stack 20 may cause a thermal damage of the internal elements of the fuel cell stack 20. It is accordingly important to regulate the temperature of the compressed air supplied from the air supplier 26 and cool down the compressed air by means of the flow of the cooling medium and the radiator 40. The technique of the invention is thus preferably applied to the heat exchanger 27. This arrangement attains the sufficient cooling of the compressed air through multiple cycles of heat exchange between the compressed air and the cooling water in the heat exchanger 27. Even the flow of cooling water at a relatively high temperature for cooling down the compressed air thus ensures the stable power generation by the fuel cell stack 20.

The exothermic equipment 13 further include the driving motor 35 that produces the driving force of the fuel-cell vehicle 10. The driving motor 35 has a relatively high heat release value during its operation. It is accordingly important to regulate the temperature of the driving motor 35 and cool down the driving motor 35 by means of the flow of the cooling medium and the radiator 40. The technique of the invention is thus preferably applied to the driving motor 35. The driving motor 35 has the oil cooling mechanism 60 that oil-cools the inside of the driving motor 35. This arrangement attains the sufficient cooling of the driving motor 35. Even the flow of cooling water at a relatively high temperature thus ensures the stable operations of the driving motor 35.

The embodiment discussed above is to be considered in all aspects as illustrative and not restrictive. There may be many modifications, changes, and alterations without departing from the scope or spirit of the main characteristics of the present invention.

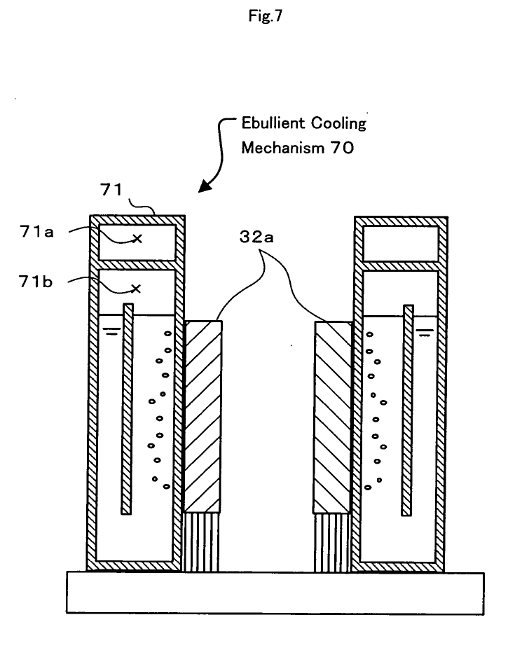

For example, in the structure of the embodiment, the dual cooling mechanism 50 is adopted to make the circulating flow of cooling water to remove the heat from both the faces of the individual semiconductor chips 32a and thereby cool down the semiconductor chips 32a. An ebullient cooling mechanism 70 using a CFC's substitute (for example, HFC-134a) as a phase change medium may alternatively be adopted to cool down the semiconductor chips 32a as shown in FIG. 7. The ebullient cooling mechanism 70 uses ebullient cooling vessels 71 that are attached to the semiconductor chips 32a in a heat transmittable manner. Each of the ebullient cooling vessel 71 has a medium container 71b that keeps the CFC's substitute therein and a circulation hole 71a that is connected with the exothermic equipment flow path 41b and makes the circulating flow of cooling water. Heat is removed from the semiconductor chips 32a in the process of vaporization of the CFC's substitute. The flow of cooling water running through the exothermic equipment flow path 41b and the circulation hole 71a removes the heat from the vaporized CFC's substitute. In this manner, the ebullient cooling mechanism 70 condenses the CFC's substitute and cools down the semiconductor chips 32a. This arrangement attains the sufficient cooling of the semiconductor chips 32a by utilizing the evaporative latent heat produced in the course of ebullience of the CFC's substitute. Even the flow of cooling water at a relatively high temperature thus ensures the stable operations of the inverter 32. In this ebullient cooling mechanism 70, the ebullient cooling vessels 71 are attached to the respective single faces of the semiconductor chips 32a. This ebullient cooling mechanism 70 may be replaced by a dual-sided ebullient cooling mechanism that uses the ebullient cooling vessels 71 attached to both the faces of the respective semiconductor chips 32a. Such modification enhances the cooling efficiency of the semiconductor chips 32a. The phase change medium is not restricted to the CFC's substitute but may be water.

In the structure of the embodiment, the exothermic equipment flow path 41b is provided in parallel to the fuel cell flow path 41a, and the respective pieces of exothermic equipment 13 are located along the exothermic equipment flow path 41b. One possible modification may omit the exothermic equipment flow path 41b and may arrange the fuel cell stack 20 and the respective pieces of exothermic equipment 13 in series along the fuel cell flow path 41a in the flow direction of cooling water. This modification further simplifies the structure of cooling down the fuel cell system. In this modified structure, the respective pieces of exothermic equipment 13 may be arranged along the cooling water flow path 41 in the order of allowable operating temperature or in the order of heat discharge.

In the structure of the embodiment, the exothermic equipment flow path 41b is provided in parallel to the fuel cell flow path 41a, and the multiple pieces of exothermic equipment 13 are arranged in series along the exothermic equipment flow path 41b in the flow direction of cooling water. In one modified structure, multiple exothermic equipment flow paths 41b are provided in parallel to the fuel cell flow path 41a, and each piece of the exothermic equipment 13 is located exclusively in one corresponding exothermic equipment flow path 41b. Unlike the structure of arranging multiple pieces of the exothermic equipment 13 in series along the flow direction of cooling water, this arrangement prevents each piece of the exothermic equipment 13 from heating up the flow of cooling water running through another piece of the exothermic equipment 13 and thus attains the efficient cooling of each piece of the exothermic equipment 13. Instead of arranging the multiple pieces of exothermic equipment 13 exclusively in the corresponding exothermic equipment flow paths 41b, one or plural pieces of exothermic equipment 13 may be selectively arranged alone or in series in each of the multiple exothermic equipment flow paths by taking into account the heat discharge quantities and the allowable operating temperatures of the respective pieces of exothermic equipment 13.

In the structure of the embodiment, the multiple pieces of exothermic equipment 13 are arranged in series along the exothermic equipment flow path 41b in the flow direction of cooling water in the ascending order of heat discharge quantity. In one possible modification, the multiple pieces of exothermic equipment 13 may be arranged in series along the exothermic equipment flow path 41b in the flow direction of cooling water in the ascending order of allowable operating temperature. Among the exothermic equipment 13, it is assumed that the allowable operating temperature increases in the order of the heat exchanger 27, the inverter 32 of the PCU 30, the air supplier 26, the driving motor 35. In this case, the heat exchanger 27, the inverter 32 of the PCU 30, the air supplier 26, and the driving motor 35 among the exothermic equipment 13 may be arranged in series along the exothermic equipment flow path 41b in the flow direction of cooling water in this ascending order of allowable operating temperature. Namely the exothermic equipment 13 having the lower allowable operating temperature is cooled down at the earlier timing. This modified arrangement desirably keeps the temperatures of the respective pieces of exothermic equipment 13 within their allowable operating temperatures. Another modification may take into account both the allowable operating temperatures and the heat discharge quantities of the respective pieces of exothermic equipment 13. In this modification, the multiple pieces of exothermic equipment 13 may be arranged along the exothermic equipment flow path 41b in the flow direction of cooling water to minimize the temperature rise of cooling water after each piece of exothermic equipment 13 and cool down each piece of exothermic equipment 13 within its allowable operating temperature. This modified arrangement also attains the sufficient cooling of the exothermic equipment 13 to keep the temperatures of the respective pieces of exothermic equipment 13 within their allowable operating temperatures. The arrangement of the exothermic equipment 13 by taking into account both the allowable operating temperature and the heat discharge quantity is identical with the arrangement by taking into account only the heat discharge quantity adopted in the embodiment.

In the structure of the embodiment described above, the exothermic equipment 13 include the inverter 32 of the PCU 30, the air supplier 26, the heat exchanger 27, and the driving motor 35. The exothermic equipment 13 may be any devices and units that produce heat during their operations and may include the accumulator 34 and the hydrogen pump 24 as well as a DC-DC converter and a booster converter for boosting up the voltage of the accumulator 34.

In the embodiment described above, the cooling device 12 is mounted on the fuel-cell vehicle 10 (automobile). The technique of the invention is not restricted to such automobiles but may be applied to various moving bodies including trains, boats and ships, and aircraft and power generation systems in houses and in power plants.

The present application claims the priority from Japanese Patent Application No. 2004-172697 field on Jun. 10, 2004, the contents of which are hereby incorporated by reference into this application.

### INDUSTRIAL APPLICABILITY

The technique of the invention is preferably applied to diversity of industries utilizing fuel cells, for example, vehicle-related industries including automobiles, trains, ships and boats, and aircraft, housing and power generation industries utilizing fuel-cells cogeneration systems, and precision equipment-related industries including system computers.

1. A cooling device for fuel cells, comprising:
fuel cells that generate electric power through an electrochemical reaction of a fuel gas with an oxidizing gas;
exothermic equipment including multiple pieces of exothermic equipment that is different from the fuel cells and produces heat during operation thereof;
a cooling medium flow path that is arranged to make circulation of a cooling medium and cool down the fuel cells and the exothermic equipment; and
a radiator that is connected with the cooling medium flow path to remove heat from the cooling medium, wherein
the multiple pieces of exothermic equipment are arranged along the cooling medium flow path, based on allowable operating temperatures or heat discharge quantities.

2. (canceled)

3. A cooling device for fuel cells in accordance with claim 1, wherein, when the multiple pieces of exothermic equipment are arranged along the cooling medium flow path based on allowable operating temperatures, the multiple pieces of exothermic equipment are arranged in series along the cooling medium flow path in a flow direction of the cooling medium in an ascending order of allowable operating temperature.

4. (canceled)

5. A cooling device for fuel cells in accordance with claim 1, wherein, when the multiple pieces of exothermic equipment are arranged along the cooling medium flow path based on heat discharge quantities, the multiple pieces of exothermic equipment are arranged in series along the cooling medium flow path in a flow direction of the cooling medium in an ascending order of heat discharge quantity.

6. A cooling device for fuel cells in accordance with claims 1, wherein the cooling medium flow path includes a fuel cell flow path that makes circulation of the cooling medium from the radiator via the fuel cells to the radiator, and at least one exothermic equipment flow path that is placed in parallel to the fuel cell flow path and makes circulation of the cooling medium from the radiator via the exothermic equipment to the radiator.

7. A cooling device for fuel cells in accordance with claim 6, wherein the multiple pieces of exothermic equipment are arranged in a series along the exothermic equipment flow path in a flow direction of the cooling medium in an ascending order of allowable operating temperatures.

8. A cooling device for fuel cells in accordance with claim 6, wherein the multiple pieces of exothermic equipment are arranged in a series along the exothermic equipment flow path in a flow direction of the cooling medium in an ascending order of heat discharge quantity.

9. A cooling device for fuel cells in accordance with claim 1, wherein the exothermic equipment includes a power converter that uses a semiconductor chip to convert the electric power generated by the fuel cells.

10. A cooling device for fuel cells in accordance with claim 9, wherein the power converter has a dual cooling mechanism that makes the cooling medium remove heat directly or indirectly from both faces of the semiconductor chip to cool down the semiconductor chip.

11. A cooling device for fuel cells in accordance with claim 9, wherein the power converter has an ebullient cooling mechanism that utilizes a phase change medium vaporized to remove heat from the semiconductor chip, and makes the cooling medium remove heat from the vaporized phase change medium to cool down the semiconductor chip.

12. A cooling device for fuel cells in accordance with claim 1, wherein the exothermic equipment includes an oxidizing gas supplier that supplies the oxidizing gas to the fuel cells.

13. A cooling device for fuel cells in accordance with claim 12, wherein the oxidizing gas supplier has a heat exchanger that makes the cooling medium remove heat from the oxidizing gas to cool down the oxidizing gas.

14. A cooling device for fuel cells in accordance with claim 13, wherein the heat exchanger cools down the oxidizing gas through multiple cycles of heat exchange between the cooling medium and the oxidizing gas.

15. A cooling device for fuel cells in accordance with claim 1, wherein the exothermic equipment includes a driving motor that produces a driving force.

16. A cooling device for fuel cells in accordance with claim 15, wherein the driving motor has an oil cooling mechanism that oil-cools inside of the driving motor.

17. A vehicle equipped with a cooling device for fuel cells in accordance with claim 1.
